(19) United States
(12) Patent Application Publication
(10) Pub. No.: US 2022/0292434 A1
(43) Pub. Date: Sep. 15, 2022

(54) RESOURCE PLANNING FOR DELIVERY OF GOODS

(71) Applicant: MICROSOFT TECHNOLOGY LICENSING, LLC, REDMOND, WA (US)

(72) Inventors: Hossein KHADIVI HERIS, El Cerrito, CA (US); Kence McCurtis ANDERSON, Martinez, CA (US); Brice Hoani Valentin CHUNG, Oakland, CA (US)

(21) Appl. No.: 17/196,371

(22) Filed: Mar. 9, 2021

(51) Int. Cl. G06Q 10/06; G06Q 10/08; G06N 20/00; G06Q 50/30

(52) U.S. Cl. CPC G06Q 10/063118; G06Q 10/083; G06N 20/00; G06Q 50/30

(57) ABSTRACT

Methods, systems, and computer programs are presented for scheduling resources used for package delivery. One method includes an operation for initializing a reinforcement learning (RL) agent that calculates staff requirements for performing jobs, each job including a delivery of a package to a respective location. The method further includes training the RL agent by performing a set of iterations. Each iteration includes operations for accessing job data, the job data including jobs for delivery, coordinates for the deliveries, and deadlines for the deliveries; generating clusters in a map for the jobs using unsupervised learning; generating the staff requirements by the RL agent based on feature extraction from the spatial and temporal distribution of the jobs; calculating a reward for the generated staff requirements; and modifying the RL agent using reinforcement learning based on the reward. Further, the trained RL agent is utilized for determining staff requirements for new jobs.

### TECHNICAL FIELD

The subject matter disclosed herein generally relates to methods, systems, and machine-readable storage media for planning use of available resources to deliver goods at multiple locations.

### BACKGROUND

One of the challenges in logistics for delivering goods, to multiple locations utilizing multiple vehicles and multiple drivers, is to find the best allocation of drivers to vehicles in determining the routes that the drivers will follow to deliver the goods. The problem arises in multiple scenarios, such as package deliveries to homes, delivering luggage between connecting flights, commercial product distribution, etc.

As the number of goods to be delivered and the number of delivery locations grow, the problem grows exponentially and finding optimal solutions becomes increasingly challenging. The complexity of the problem grows in the presence of uncertainty, such as accounting for the possibility that the goods are not available on time, or human resources not available when needed. Most companies rely on heuristic algorithms and human expertise to plan their deliveries, but there is great room for optimizing the use of resources, an optimization that can bring great savings for the expenses incurred in delivering the goods. The savings may arise by reducing staff expenses, reducing the number of resources used in the distribution, or reducing the distance traveled by the drivers to deliver the goods.

### BRIEF DESCRIPTION OF THE DRAWINGS

Various of the appended drawings merely illustrate example embodiments of the present disclosure and cannot he considered as limiting its scope.

FIG. 1 illustrates the problem of distributing packages throughout a region, according to some example embodiments.

FIG. 2 illustrates a method for making resource recommendations, according to some example embodiments.

FIG. 3 illustrates the process of making assessments with reinforcement learning, according to some example embodiments.

FIG. 4 illustrates the process of defining resources using constraint programming, according to some example embodiments.

FIG. 5 is a flowchart of a method for estimating resources to be used in package delivery, according to some example embodiments.

FIG. 6 is an architectural diagram for implementing embodiments.

FIG. 7 illustrates the generation of hypothetical data ahead of the actual scheduled data, according to some example embodiments.

FIG. 8 illustrates the data preprocessing and feature extraction for use with the reinforcement learning agent, according to some example embodiments.

FIG. 9 illustrates the use of constraint programming for reinforcement learning, according to some example embodiments.

FIG. 10 illustrates the simulation environment with reinforcement learning for training the agent, according to some example embodiments.

FIG. 11 illustrates the scenario with nonoverlapping shifts.

FIG. 12 illustrates calculating the staff required for nonoverlapping shifts, according to some example embodiments.

FIG. 13 illustrates the scenario with overlapping shifts and dynamic depot locations, according to some example embodiments.

FIG. 14 illustrates calculating the staff required for overlapping shifts and dynamic depot locations, according to some example embodiments.

FIG. 15 is a flowchart of a method for scheduling resources used for package delivery, according to some example embodiments.

FIG. 16 is a block diagram illustrating an example of a machine upon or by which one or more example process embodiments described herein may be implemented or controlled.

### DETAILED DESCRIPTION

Example methods, systems, and computer programs are directed to scheduling resources used for package delivery. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may he practiced without these specific details.

A scalable method for planning staffing needed for deliveries is presented. The methodology leverages a combination of reinforcement learning, constraint programming, unsupervised learning, and time-frequency binning methods to solve the staffing problem, in the presence of uncertain conditions, to determine the optimal use of resources (e.g., drivers, vehicles) and the selection of the best routes for delivery.

Although implementations are presented for package delivery to multiple sites, the same principles may be utilized in many types of supply chain and logistics problems, such as in the areas of manufacturing, retail, distribution services, people ridesharing, food delivery services, taxi services, delivery of online e-commerce, and so forth.

One general aspect includes a method that includes an operation for initializing a reinforcement learning (RL) agent that calculates staff requirements for performing jobs, each job including a delivery of a package to a respective location. The method further includes training the RL agent by performing a set of iterations. Each iteration includes operations for accessing job data, the job data including jobs for delivery, coordinates for the deliveries, and deadlines for the deliveries; generating clusters in a map for the jobs using unsupervised learning, each cluster comprising one or more jobs from the plurality of jobs; generating the staff requirements by the RL agent based on the clusters; calculating a reward for the generated staff requirements; and modifying the RL agent using reinforcement learning based on the reward. Further, the trained RL agent is utilized for determining staff requirements for new jobs.

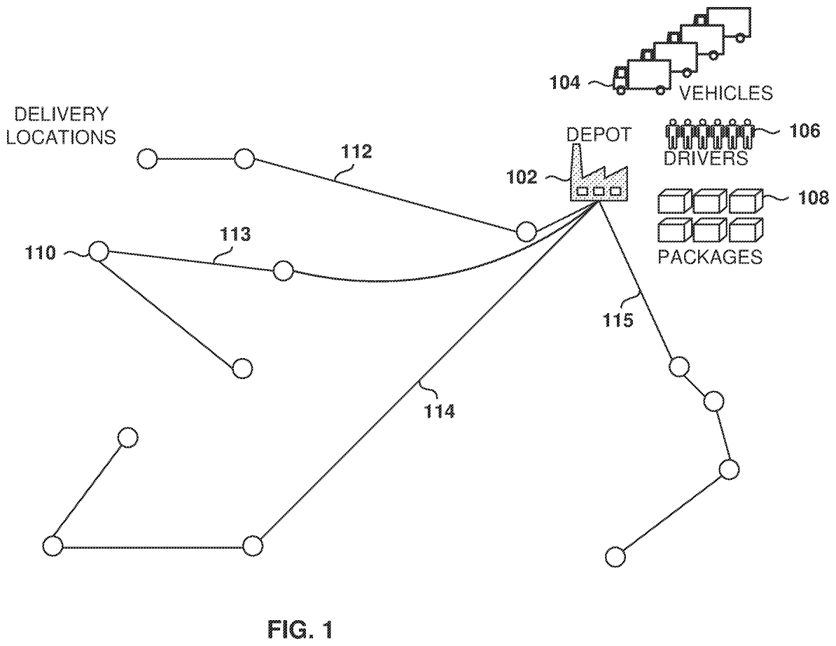

FIG. 1 illustrates the problem of distributing packages throughout a region, according to some example embodiments. The illustrated scenario includes vehicles 104 and drivers 106 at a depot location 102 to deliver packages 108. The packages 108 are to he delivered to multiple locations 110.

The goal is to plan in advance how to deliver the packages 108, even before the packages 108 arrive at the depot 102, that is, the goal is to plan for the required staff as well as tentative delivery orders and routes. The staff planning and delivery orders and routes will become more accurate as we get closer to the delivery time. For example, a logistics manager wants to come up with a plan for deliveries for the next day, which means that there are probabilities associated with drivers 106 being available, vehicles 104 being available, and packages 108 at the depot being available for delivery (e.g., some packages may not arrive on time at the depot because of a delay during transport). In some example embodiments, it is assumed that the drivers will be available. In other embodiments, driver availability is considered as another constraint with a corresponding probability. In this case, the output of the RL agent includes a recommendation for the number of drivers needed. Further, individual staff availability can also be included either as part of the solution within the simulation, the same way the job shift probability is included, or it could be inferred outside the RL+CP framework.

Embodiments presented herein determine routes 112, 113, 114, 115 to deliver the packages 108 utilizing a number of vehicles 104 and drivers 106. As illustrated, each of the routes 112-115 is serviced by one of the drivers 106 and each route covers a plurality of delivery locations 110 traversed through the route.

The optimization goal is to plan for an optimal number of drivers 106 to deliver all the packages 108 on time. For example, the goal is to make package deliveries by UPS, FedEx, or Amazon, or to deliver luggage in an airport between connecting flights.

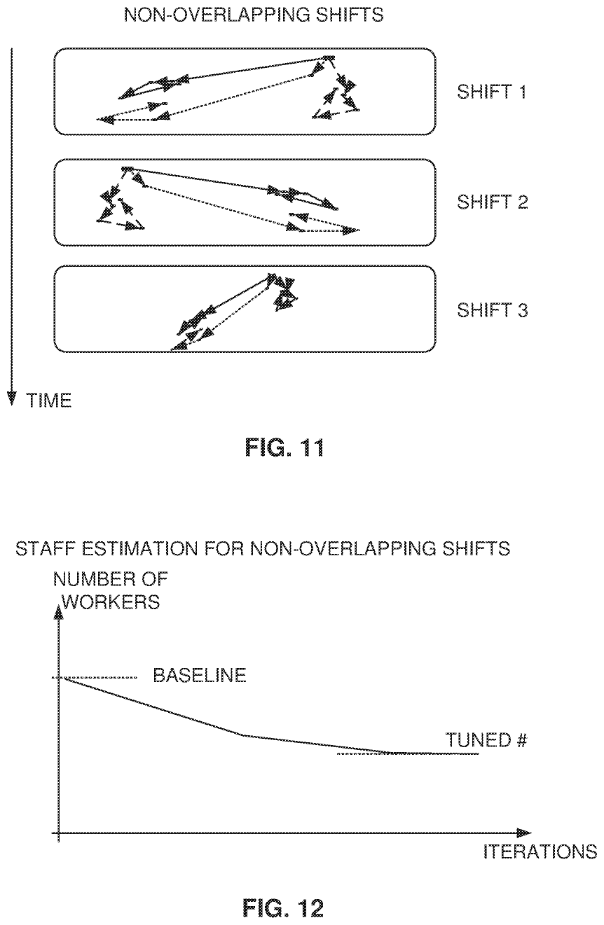

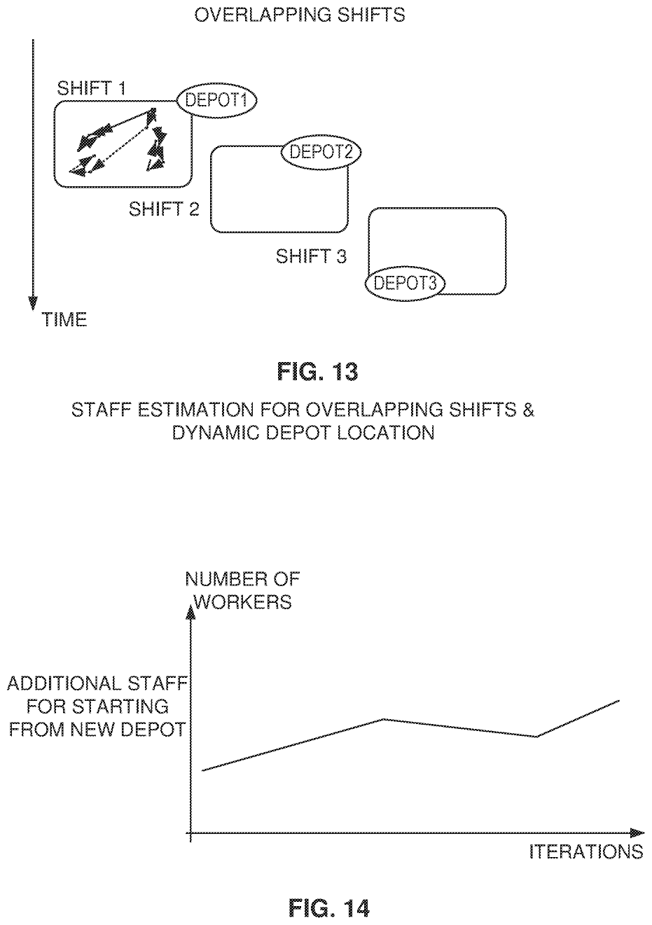

In some example embodiments, some assumptions are included. A first assumption is that a day is divided into shills, where jobs (e.g., delivering a package) need to be scheduled before the start of the shift with a specific delivery deadline (e.g., promised delivery time by a carrier, time of departing flight). If shifts are not overlapping, as shown in FIG. 11, the assumption is that all the jobs need to be completed by a predetermined maximum number of drivers (or luggage handlers) and that the drivers return to the depot upon completion of delivery. One of the goals is to determine the optimal number of drivers per shift to meet the deadlines. In this case, the sequential decision made by an RL agent is to tune the required number of staff for a given shift, as shown in FIG. 12. This methodology is also expendable to overlapping shifts and dynamic depot locations, given the sequential nature of the RL, as shown in FIG. 13, where resources can be shared across shifts starting from multiple locations. In this case, RL agent makes sequential decision of assigning additional staff needed for a given shift while sharing resources from previous shifts, as shown in FIG. 14. Further, the methodology can cover shifts with jobs created at multiple events, such as, a morning shift in an airport will require a certain number of workers, but the workers will be shared for incoming flights that can occur at any moment during the shift. In this case, the overlapping-shifts approach can be utilized.

Further, another assumption is that, since the planning is performed in advance, there is a probability that jobs may be added or canceled, as well as probabilities that there will be changes in the delivery deadlines. For example, flights may be delayed in an airport, affecting connecting flights, or some packages are delayed when a carrier encounters bad weather conditions or unexpected traffic on the road.

Additionally, the system may have other constraints that must be considered when planning, such that each vehicle has a limited amount of capacity for packages or that drivers are limited to operate at certain shifts.

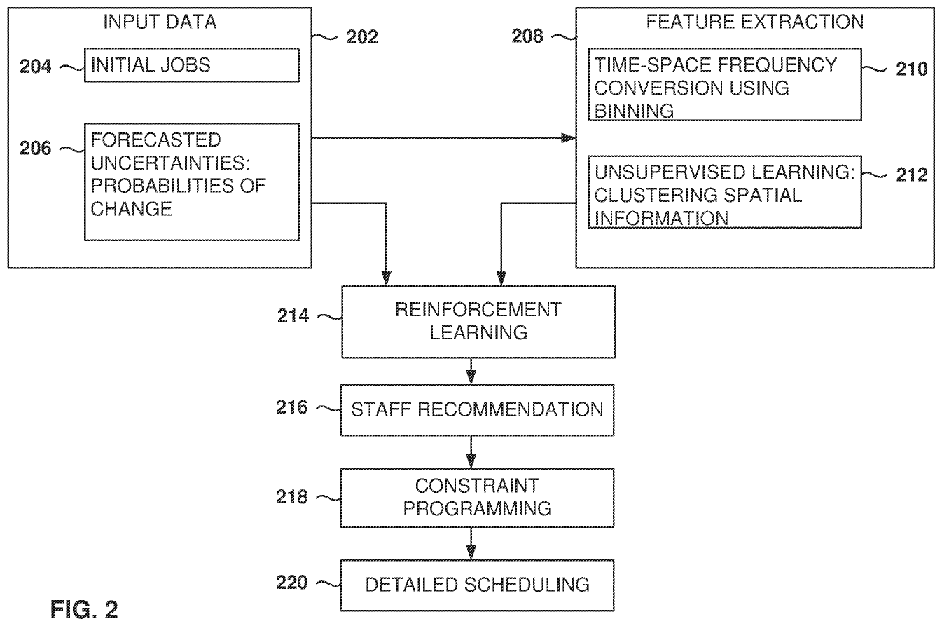

FIG. 2 illustrates a method for making resource recommendations, according to some example embodiments. The input data 202 includes information about the initial jobs 204 to he scheduled and forecasted uncertainties 206. As used herein, a job refers to the delivery of one item to one location, although some locations may receive multiple deliveries, which means that multiple jobs will be assigned to the multiple deliveries. Further, the forecasted uncertainties 206 refer to the probabilities of changes in the planning of the deliveries, which may include probabilities of canceling jobs, adding jobs, moving delivery deadlines, staff being available, vehicles being available, etc.

The inputs 202 are fed into a feature extraction module 208, which includes a time-space frequency conversion using binning 210, and unsupervised learning 212 regarding the clustering of spatial information (e.g., clustering of sites for delivery of packages). It is noted that the method features are presented as examples and other features may be also included, such as an average and a standard deviation of the driver's travel time. Further, other features can be extracted from the solution of the CP, in addition to the ones extracted from the job schedule.

The input data 202 and the result of the feature extraction 208 are inputs to the reinforcement learning agent 214, which uses reinforcement learning techniques to determine staff recommendation 216 (e.g., how many drivers, routers for delivery). The staff recommendation 216 is used by constraint programming 218 to produce a detailed scheduling or plan for the deliveries. It is noted that the reinforcement learning and the constraint programming may operate iteratively during training of Machine-Learning (ML) models to perform multiple simulations until the training is completed.

This technical approach presents a unique problem decomposition, decoupling staff planning and detailed job scheduling. Other solutions may neglect the uncertainties inherent to predicting the future.

In some example embodiments, the routing problem is solved using constraint programming 218, which provides better solutions for dealing with constraints.

In other solutions, constraints are often very limited or non-existing, but by using constraint programming 218, it is possible to include as many constraints as desired regarding resources, staff, possibilities of change, etc. Further, by using reinforcement learning 214, it is possible to account for uncertainty by using probabilities for resources and jobs. This allows for re-evaluating and improving staffing recommendations as forecasts become more accurate.

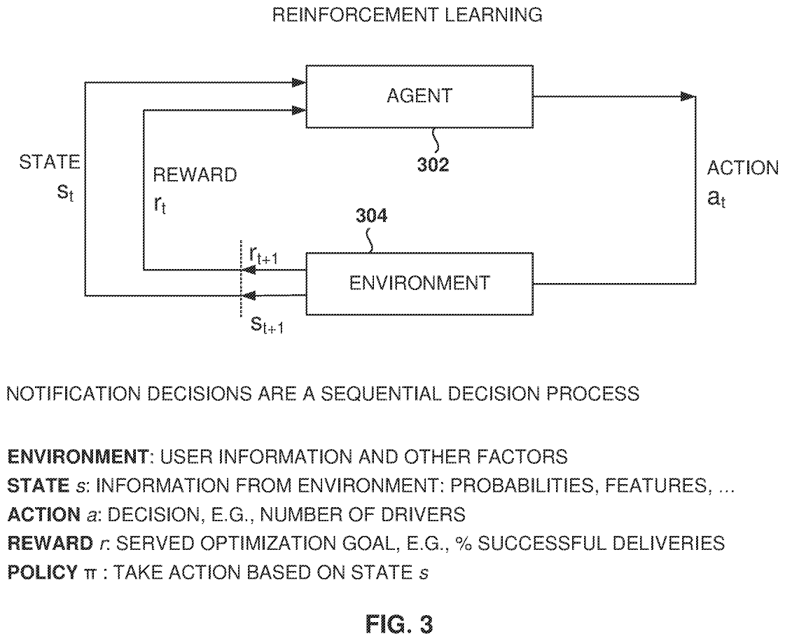

FIG. 3 illustrates the process of making assessments with reinforcement learning, according to some example embodiments, Reinforcement learning (RL) is an area of machine learning concerned with how software agents ought to take actions in an environment to maximize a cumulative value of a parameter, which is referred to as cumulative parameter value or cumulative reward. The cumulative value of the parameter is the addition of the values of the parameter (e.g., the reward) over time, such as the value of the parameter at different states. RL is one of three basic machine learning paradigms, alongside supervised learning and unsupervised learning. RL differs from supervised learning in that labelled input-output pairs need not be presented, and sub-optimal actions need not be explicitly corrected. Instead the focus is finding a balance between exploration (of uncharted territory) and exploitation (of current knowledge).

The environment (e.g., environment 304) is typically formulated as a Markov decision process (MDP), as many reinforcement learning algorithms for this context utilize dynamic programming techniques, RL includes sequential states, where each state has an action (e.g., decision), and the sequential decision making is for maximizing a total reward over a given horizon, while the system evolution is impacted by the actions taken at each state.

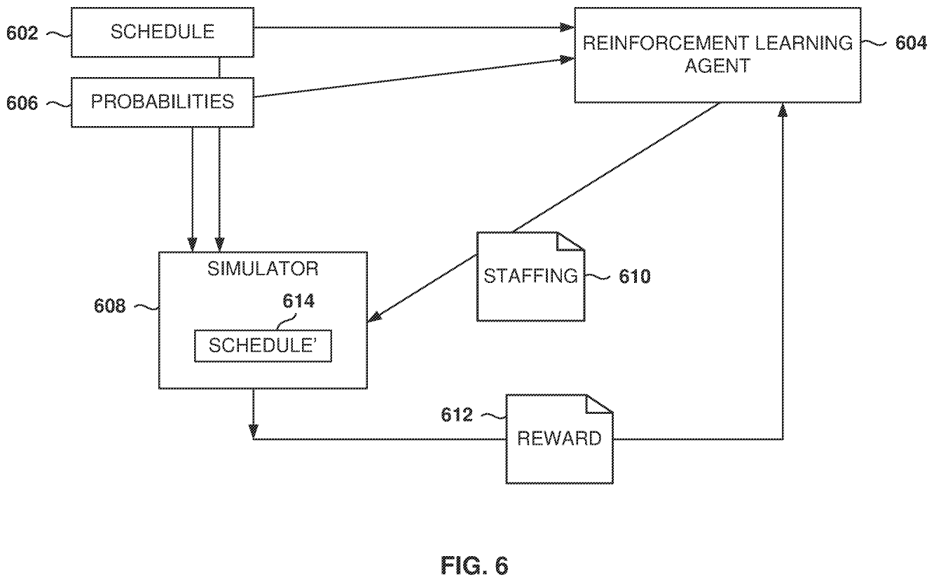

Reinforcement learning systems learn what to do given the situation so as to maximize some numerical value which represents a long-term objective. In a typical setting, an agent 302 receives the state sₜ of the environment 304 and a reward rₜ associated with the last action aₜ₋₁ and state transition. RL then chooses an action aₜ based on RL's policy. In response, the system makes a transition to a new state sₜ₊₁ and the cycle is repeated. The problem is to learn an RL policy for the agent 302 (e.g., the reinforcement learning agent 604 of FIG. 6) to maximize the total reward for all states. Differently from supervised learning, with RL, only partial feedback is given to the learner about the learner's predictions.

In a standard reinforcement learning setting, an agent interacts with the environment over a number of discrete time steps. At every time step t, the agent receives a state sₜ and chooses an action aₜ according to a policy which is a deterministic or stochastic mapping from states sₜ to actions aₜ. In return, the agent receives the next state sₜ₊₁ and a scalar reward rₜ. This long-term reward is defined as Rₜ=Σₖ₌₀^{∞}γ^{k}rₜ₊ₖ, where γ∈(0,1] is the discount factor. This discount factor controls the tradeoff between the short-term optimization and long-term optimization. The goal of the agent is to maximize the expected Rₜ.

in some example embodiments, the environment 304 includes information about the jobs and the resources (e.g., number of jobs, delivery locations, probabilities', deadlines, resources), and the CP solver as a mechanism to identify the agent's reward.

A state s is a function of the history. An informative state contains all useful information from the history to ensure Markov decision process:

P(sₜ₊₁|sₜaₜ)=P(sₜ₊₁|s₁, . . . , sₜ, a₁, . . . , aₜ).

Since Markov decision process is the foundation for reinforcement learning algorithms, states have to be defined properly to ensure that the state captures all relevant information from the history. More information regarding the state is provided below with reference to FIG. 6.

The action a is the decision to send or not send a notification. Further, the reward r denotes an immediate reward. Since the decision to send is evaluated periodically (e.g., every four hours), the reward is based on how much value a user gets during the period between decisions. In some example embodiments, the reward is the cost of delivering the jobs as measured by resources used to delivered and time taken for delivering (e.g., meeting deadlines)

The policy π is a mapping from the state space to the action space, either deterministic or stochastic. For every Markov decision process, there exists an optimal deterministic policy, π*, which maximizes the long-term reward from any initial state.

The value of state s under policy π is defined as follows:

V^{π}(s)=E(Rₜ|sₜ=s),

Here, E is the expected return for following policy π from state s. An optimal policy is

$${V}^{*} ( s ) = {max}_{a ∈ A} {Q}^{*} ( s , a ) .$$

policy π is defined as Q^{π}(s,a)=E[rₜ|sₜ=s,a], which maps a state and an action to an expected value of the total reward over all successive steps, starting from the current state.

Further, the optimal state-value function

$${Q}^{*} ( s , a ) = {max}_{π} {Q}^{π} ( s , a )$$

gives the maximum action value for state s and action a achievable by any policy. it is noted that embodiments may also utilize other RL algorithms, such as DQN, PPO (policy gradient methods), actor-critique methods, etc. The optimal value and action-value functions are connected as follows:

$${V}^{*} ( s ) = {max}_{π} {V}^{π} ( s ) , s ∈ S .$$

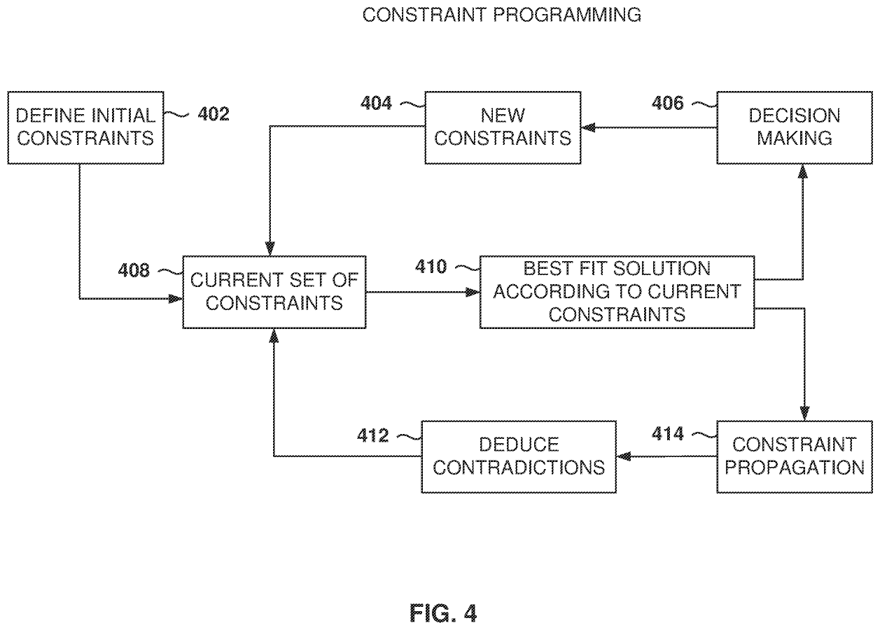

FIG. 4 illustrates the process of defining resources using constraint programming (CP), according to some example embodiments. CP is a process to identify feasible solutions out of a large set of candidates, where the problem can be modeled in terms of constraints. in constraint programming, users declaratively state the constraints on the feasible solutions for a set of decision variables. CP differs from common programming languages in that solutions do not specify a sequence of steps to execute, but rather the properties of a solution to be found. Further, in additions to constraints, a method is provided to solve the constraints, e.g., chronological backtracking and constraint propagation, but may use a customized code like a problem specific branching heuristic. With CP, the goal is to find a state in which the constraints are simultaneously satisfied. A constraint is defined as a limitation on the values for the system parameters that satisfy a desired solution. in some example embodiments, a constraint refers to a condition that the planning of the deliveries has to meet, such as using available staff for a given shift, using available vehicles, meeting delivery deadlines, and so forth. CP is used in simulation for detailed routing and allocation of resources, and for rewarding the agent based on resource allocation. CP makes the best estimation on how to use the resources for a detailed routing, and CP gives the best estimate of the detailed routes for a given number of resources.

With CP, the programmer defines an initial set of constraints 402, which at a first iteration becomes the current set of constraints 408. From the current set of constraints 408, the constraint programming module determines the best-fit solution 410 based on the current set of constraints 408. As solutions are developed and tested, decisions are made 406 as to whether new constraints 404 must be developed and added to the current set of constraints 408. Additionally, decisions, regarding constraint propagation 414 for the new iteration, are made on how to deduce the contradictions 412 to determine if there are any constraints, from the current set of constraints 408, that must be modified or retracted to remove duplications.

The process cycles through current set of restraints 408 and solutions until a solution is developed that meets all the constraints and solves the problem that matches the defined initial constraints 402. CP is well suited for job scheduling because many constraints may be included, such as a availability of each person in the staff to work in each of the shifts, delivery deadlines for each of the packages, availability of vehicles, capacity of each vehicle for carrying packages, limiting the cost of delivery, load times for the packages on the vehicles, etc.

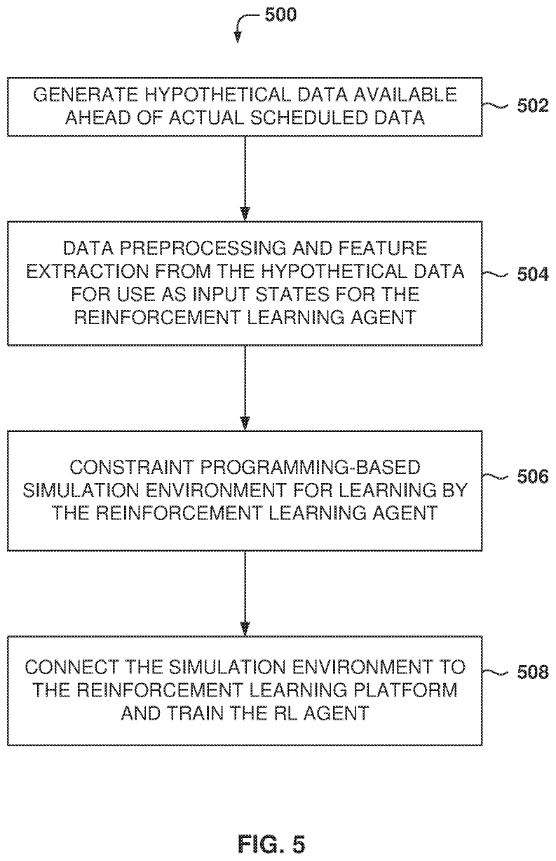

FIG. 5 is a flowchart of a method 500 for estimating resources to be used in package delivery, according to sonic example embodiments. While the various operations in this flowchart are presented and described sequentially, one of ordinary skill will appreciate that some or all of the operations may be executed in a different order, be combined or omitted, or be executed in parallel.

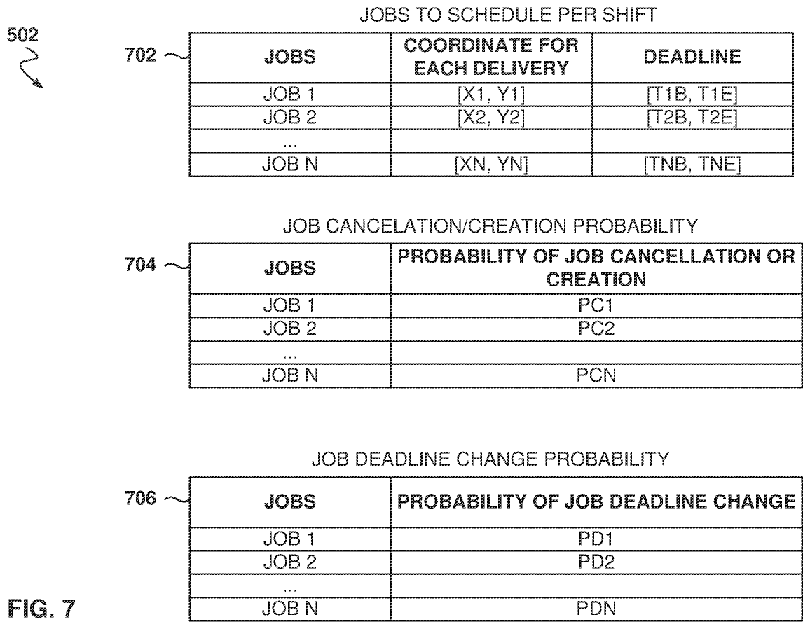

At operation 502, hypothetical data available is generated ahead of the actual schedule data. This includes initial estimates for job information. More details for operation 502 are provided below with reference to FIG. 7.

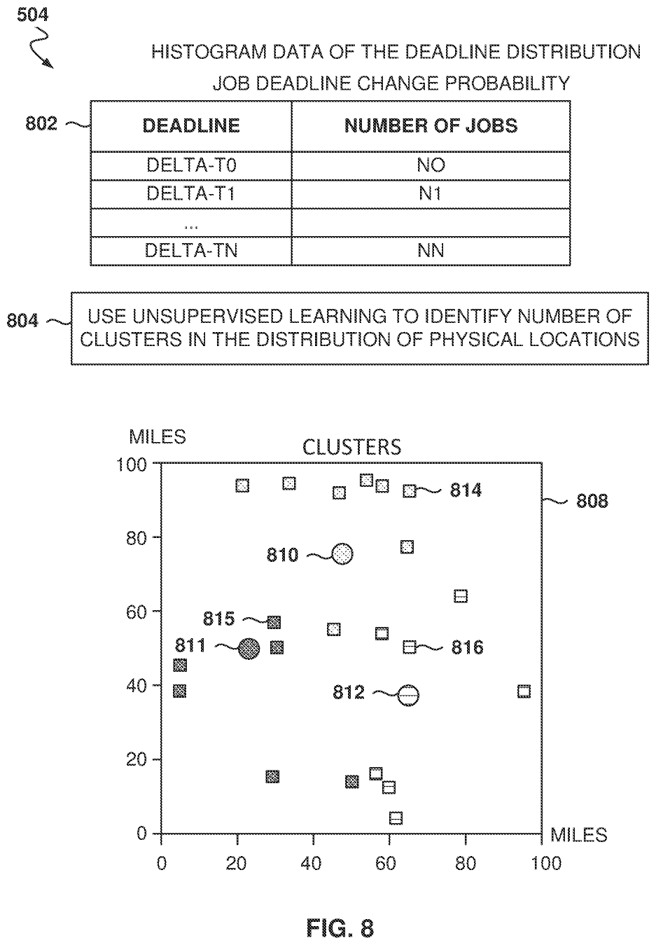

From operation 502, the method 500 flows to operation 504 to perform data preprocessing and feature extraction from the hypothetical data to be used as input states for the RL agent. More details for operation 504 are provided below with reference to FIG. 8. As noted earlier, CP is used as part of the simulation for detailed schedules (tentative in advance of target date), for the reward mechanism (e.g., staff utilization, number of missed deliveries for given staff), to extract states (e.g., anticipated location of the staff, last delivered job), calculate mean and standard deviation of each driver's travel time, etc.

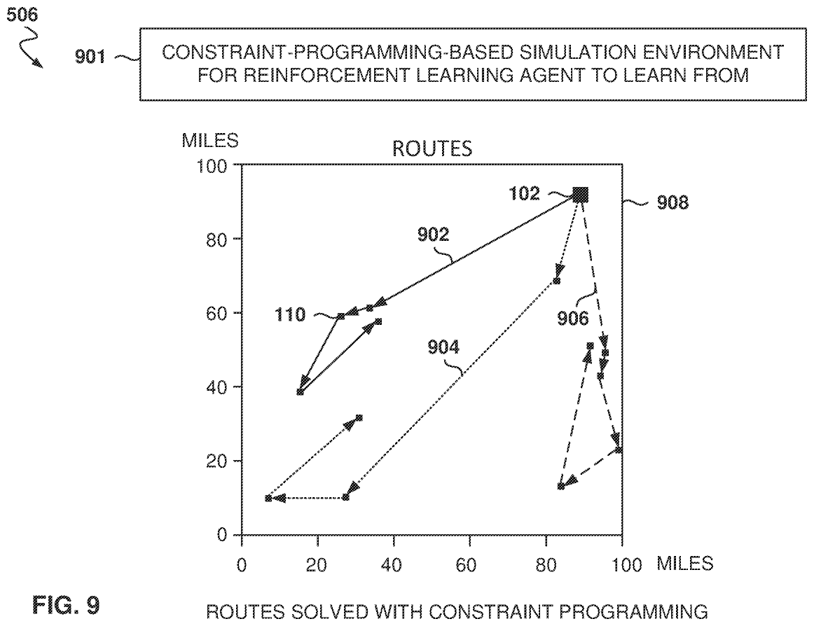

From operation 504, the method 500 flows to operation 506 where a CP-based simulation environment is utilized for learning by the RL agent. More details for operation 506 are provided below with reference to FIG. 9.

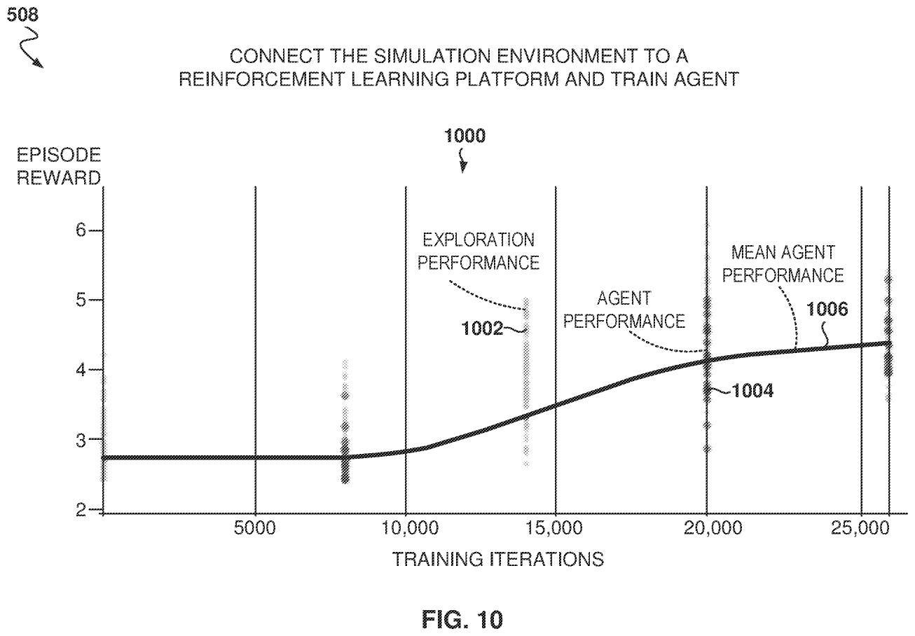

From operation 506, the method flows to operation 508 to connect the simulation environment to the RL platform and train the RL agent. More details for operation 508 are provided below with reference to FIG. 10.

FIG. 6 is an architectural diagram for implementing embodiments. The simulator 608 receives as inputs the initial schedule 602, probabilities 606 associated with the jobs and the resources, and staffing 610, which includes the number of people schedule for the delivery. The initial schedule 602 includes a list of the jobs for delivering packages with the corresponding deadlines and may also include other constraints. The RL agent 604 also receives the initial schedule 602 and the probabilities 606 and generates the staffing 610, which defines the drivers and the routes for the drivers to make the deliveries.

The simulator 608 generates a new schedule 614, referred to as schedule', and the RL agent 604 calculates the reward R 612 for the schedule' 614. The simulator 608 can also take historical data and mix with synthetic data generation, where the synthetic data can follow certain distribution based on modeling of the historical data, or it can be generated randomly. The reward R indicates the value of the decision for the staffing and the schedule (e.g., higher reward for a job that uses less resources and takes less amount of time for delivery than another job). In some example embodiments, the reward R is a linear calculation for the number of drivers, the time estimated for making the deliveries, the number of missed deliveries, and the distance travelled to do the deliveries, but other embodiments may use other types of rewards.

In some example embodiments, an assumption is used where no job can be missing in favor of creating optimal routes. Iterations with missed deliveries are either terminated or assigned with a large negative reward. For iterations with no missed deliveries, the unused personnel is calculated from CP results (e.g., drive time=0), and/or the underutilized personnel is calculated e.g., drive time is less than the mean minus two standard deviations). For this assumption, different reward calculations may be used: single (based on one parameter), combination (based on several parameters), and hierarchical (based on using different formulas based on the conditions). Thus, the reward R may be calculated as follows:
Single: R=^{-unitilized_drivers.},
Combination: R=e^{-unitilized_drivers}+w₁*underutilized_drivers, where w₁ can be tuned based on two objectives; and
Hierarchical: if underutilized_drivers>0 then R=e^{-unitilized_drivers} else R=1+e^{unitilized_drivers}

In some example embodiments, the assumption is that some deliveries may be missing in favor of creating more optimal routes. In this case, the number of allowed drops is defined based on business requirements, and drops and unutilized_personnel are returned from the CP solution. For this assumption, different reward calculations may be used: combination (based on several parameters) and hierarchical (based on using different formulas based on the conditions). Thus, the reward R may be calculated as follows:
Combination: R=e^{-(drops-allowed_drops)}+w₂*e^{-(unutilized_staff)}, where w₂ is a tuning parameter to adjust the trade-off between the two parameters.
Hierarchical: if drops>allowed_drops then R=e^{-(drops-allowed_drops)}
   else R=1+e^{-(unutilized_staff)}

The simulator uses the schedule 602, which includes associated probabilities for changes of the job parameters, and uses these probabilities to create the schedule' 614. Based on the reward R 612 and the schedule' 614, the RL agent 604 updates the staffing 610 data. The cycle is repeated multiple times until the simulation converges to a stable value with a high reward level, or until the maximum number of iterations is reached.

If the RL agent 604 receives a high R 612, the RL agent 604 will update the schedule and the staffing 610. For example, if R 612 is high, the RL agent 604 may determine that this schedule with three drives is better than the previous schedule with four drivers.

During training, the RL agent 604 updates internal parameters for the ML model that calculates the staffing 610 based on the R 612, and the updated ML model will he used in the next iteration. In some example embodiments, the RL agent 604 is Microsoft® Bonsai, a low-code Artificial Intelligence (AI) platform that speeds AI-powered automation development and is part of the Autonomous Systems suite from Microsoft. However, other agents may be utilized to implement embodiments described herein. Further, the CP simulator 608 is implemented using Google OR, but other CP engines may also be used. Once the agent is fully trained, the policy can be used in production, and given any real word schedule, and in-advance probabilities, the RL agent 604 will recommend the required staff that can deliver the jobs. Then, the detailed tentative schedule is extracted from CP by adjusting the probabilities to zero to get the schedule for a given date. The staff recommendations and detailed schedules will become more accurate as it gets closer to the actual date.

FIG. 7 illustrates the generation of hypothetical data ahead of the actual scheduled data, according to some example embodiments. in some example embodiments, the job data is generated. The job data includes jobs to be scheduled per shift, probabilities for job cancellations or job creation, and probability of changing job deadlines. The job data is obtained based on historical data from a database, or generated synthetically, or a combination thereof. In some example embodiments, the initial job data is generated by job schedulers that estimate an initial schedule based on historical data and available current data.

FIG. 7 includes some example embodiments for representing the jobs data shown in multiple tables. Table 702 includes the jobs to be schedule per shift, and the Table 702 includes one row per job to be scheduled. In each row, the fields include the job identifier (e.g., JOB 1), the coordinates (e.g., latitude and longitude, coordinates on a cartographical map) for the delivery location (e.g., [X1, Y1]), and the deadline for the delivery expressed as a possible range between a beginning time TB and an end time TE (e.g., [T1B, T1E], 9 AM and 11 AM). In some cases, TB may be equal to TE, which means that the package may be delivered any time before TE.

It is noted that if historical data is used for making the delivery plan, there may be over-fitting to the to what had happened in the past, versus what may be happening now, as the delivery places used in the past may be different than the current delivery locations. In some cases, random deliveries are generated to random locations. The simulation process utilized herein is able to generalize the problem to generic locations, job, deadlines, etc. The initial schedule is the starting point to determine a better schedule that accounts for the system constraints (e.g., probabilities of adding or canceling jobs).

Table 704 includes one row per job, with each row including the job id (e.g., JOB 1) and the probability that an existing job will be canceled or the probability that a new job will be generated. That is, the scheduling problem is dynamic, and conditions may change, such as a flight delay, a broken delivery vehicle, etc. This is why probabilities are used to account for uncertainty and the possibility that things change. In some example embodiments, Table 704 is built using historical data and supervised learning models, but any other technique may be used.

Table 706 includes one row per job, with each row including the job ID (e.g., JOB 1) and the probability that the deadline for the job will change (e.g., PD1). In some example embodiments, Table 706 is built using historical data and supervised learning models, or forecast models based on weather condition or other influencing factors, but any other technique may be used.

it is noted that the embodiments illustrated in FIG. 7 are examples and do not describe every possible embodiment. Other embodiments may utilize different columns, combine tables into one, add more columns, etc. The embodiments illustrated in FIG. 7 should therefore not be interpreted to be exclusive or limiting, but rather illustrative.

FIG. 8 illustrates the data preprocessing and the feature extraction for use with the RL agent, according to some example embodiments. At operation 504, the data from tables of FIG. 7 is preprocessed and features extracted to obtain input states for the RL agent.

Table 802 includes histogram data for the distribution of the deadlines using a fixed delta-time bin size. The size of the bins is tuned based on the application. In some example embodiments, the first bin has the closest deadline. Table 802 includes one row per bin associated with a deadline time (e.g., Delto-T0), and the number of jobs that have to meet that deadline. Thus, the first row includes the number of jobs N0 with the deadline before Delta-T0, the second row includes the number of jobs N1 between Delta-T0 and Delta-T1, and so forth.

After the histogram data is created from the job data, at operation 804, unsupervised learning is used to identify the clusters in the distribution of the physical location of the target delivers for a predetermined number of the starting deadline bins (e.g., the first three, but other values are also possible), that is, the jobs with the closest deadlines. The goal is to be able to meet the deadlines of the most urgent deliveries. The number of identifiable clusters within each bin is calculated. The earlier bins are more important as their deadlines are closer. If data indicates more clusters in earlier bins, it provides a good signal for the agent to choose a larger number of workers, for example. Further, the jobs are scheduled according to CP, and CP does not schedule the jobs bin to bin but rather takes into account all the jobs in all bins. The jobs that are in the earlier bins will naturally occur as the first jobs to be delivered. Further, some of the jobs may get eliminated by CP because they are impossible to deliver. After those jobs are scheduled, the process continues with the next bins, that is, the jobs with the closest deadlines after the jobs that have already been scheduled.

Clustering is the task of dividing data points into a number of groups such that data points in the same groups are more similar to other data points in the same group than those in other groups. In simple words, the aim is to segregate groups with similar traits and assign them into clusters. In our case, the goal is to have the smallest distance possible among the delivery locations in the cluster, which will mean a faster delivery route.

Any clustering algorithm for creating the clusters based on the delivery locations may be utilized. In some example embodiments, the Scikit mean shift algorithm is used to identify the clusters.

The bins with the tightest deadlines tend to be the most critical because if deliveries are located far apart in different clusters, more staff will be required to complete the jobs. If the delivery locations are nearby, then deliveries will require less resources. For example, for delivering bags between connecting flights, if the departure gates are nearby, then one driver can handle more jobs.

Map 808 shows a distribution of the delivery locations 814-816 in an 100×100 mi² area. The clustering program has identified three clusters with centers 810-812. The delivery locations for each cluster are presented with the same shading as the cluster centers 810-812, such as location 814 for cluster center 810, location 815 for cluster center 811, and location 816 for cluster center 812. The resulting clusters are inputs for the RL agent that calculates the staffing for the deliveries. The inputs to the RL agent are referred to as states. In same example embodiments, the states include the number of nodes at each bin, the number of clusters at each bin, and metrics extracted from constraint programming, such as mean and standard deviation of agents travel time, underutilized staff, number of missed deliveries, etc. The reward is constructed based on the number of the recommended workers (agent actions) and the states observed from the simulator after solving the schedules with CP.

FIG. 9 illustrates the use of constraint programming for reinforcement learning, according to some example embodiments. At operation 901, constraint-programming-based simulation with RL for the RL agent is used to determine the best routes. With model-free reinforcement learning, the system learns from simulations. The simulation creates a synthetic schedule or obtains one from historical jobs available in advance, or a combination thereof. Further, the simulation takes agents' action as the number of workers, and uses the probabilities to generate a new schedule, or use the historical data on the actual date, solves for routes using CP and then returns the solution related to the states (e.g., number of missed deliveries, location of the last delivery, etc.). These states can be used as states for the next iteration and some states may be used for constructing reward metrics (e.g., number of missed deliveries). Then, the simulator uses simulation for the new schedule, with input from the RL agent, and the result is the number of drivers in the routes.

For example, if the schedule misses deadlines for some deliveries, the reward will be low. Also, if there is staff idle on one shift, this will also lower the amount of the reward because of the unutilized staff.

The RL agent learns from the simulation environment that mimics the real word, as opposed to supervised learning that learns directly form the data. The simulator utilizes the inputs described in FIG. 7 as well as the number of available drivers. As described above with reference to FIG. 6, the simulator 608 reads the tentative job schedules and probabilities, and generates the final schedule while solving the routing problem at the granular level using constraint programing.

The outputs of the simulator include the number of missed deliveries, the route for each driver, and the distance traveled by each driver. Map 908 shows that there are three routes 902, 904, 906 for three drivers starting at the depot 102, and each route has the delivery locations.

In some cases, the Euclidian distance is used as the node-to-node distance. However, in some real word applications where routes are not necessarily straight, other algorithms may be used, such as the Dijkastra algorithm, or the Floyd-Warshall algorithm, to calculate the closet distance between the nodes. These distances can be calculated once and cached later for some applications, e.g., airport baggage delivery, where gate locations are pre-defined. For other cases such as city locations, the closest distance can be calculated on the fly. The distance between the nodes is one of the inputs to CP.

FIG. 10 illustrates the simulation environment with reinforcement learning for training the agent, according to some example embodiments. Chart 100 shows the reward of each simulation (vertical axis) across the training iterations (horizontal axis).

As the number of iterations for calculating the staffing required for the deliveries grow, the mean performance 1006 of the RL agent improves at the beginning and then stops substantially growing as the number of iterations reaches around 25,000. In some example embodiments, the goal of the optimization is to minimize the number of required drivers while minimizing the number of missed deadlines for the deliveries of the packages.

In some example embodiments, curriculum learning is utilized. In curriculum learning, the number of simulations is limited to a certain value (e.g., 1000 simulations) or a given time period (e.g., 10 minutes). Based on the learned data from the simulations, the parameters of the system (e.g., the parameters of a neural network implementing the RL agent) are adjusted and then new simulations are performed. The process repeats until the solution converges to the optimal value. Thus, the system may start with random parameters, which are adjusted after each set of simulations. Chart 100 shows the rewards 1002 during exploration phases and rewards 1004 calculated by the RL agent.

As in the illustrated example in chart 1000 shows, the initial reward is small (less than 3), which means that the delivery routes and driver utilization are less than optimal. As the member of simulations grow, the reward keeps growing to a value of around 5.5, which indicates that the RL agent is determining schedules that utilize drivers better and is able to meet deadlines better.

After the training of the RL agent is complete, the RL agent is used to determine staffing needs for actual real-life cases. This means that the RL agent takes as input the job requirements and generates the staffing required to deliver packages for those jobs and the routes for delivering the packages, hours, days, or weeks in advance, depending on the application.

FIG. 11 illustrates the scenario with nonoverlapping shifts. In this scenario, the shifts do not overlap with each other, that is, one shift does not start until the previous shift ends. Further, the drivers return to the depot before the end of each shift.

Further, the locations of the starting depot and the ending depots may be the same or different, and the staffing for each shift can be treated independently.

FIG. 12 illustrates calculating the staff required for nonoverlapping shifts, according to some example embodiments. In this scenario, an agent interacts with a random shift at every episode, Within each episode, and agent finetunes the number of workers depending on the feedback from the environment. The RL agent gets multiple chances to tune the number of workers, based on the fact that, at every iteration, the job schedules are changed with respect to the provided probabilities. For any chosen shift, during each iteration, the jobs are updated based on the probabilities.

FIG. 13 illustrates the scenario with overlapping shifts and dynamic depot locations, according to some example embodiments. In this scenario, the shifts may overlap and the depots may be in different locations.

A discrete event simulator runs a heuristic program in conjunction with constraints programming to share drivers between shifts and make an optimal use of the available drivers across multiple depot locations and shifts. At every iteration, the RL agent receives information about the drivers that have completed their jobs from previous iterations and are available to start a new shift, and calculates the additional staff that needs to be scheduled from each depot.

FIG. 14 illustrates calculating the staff required for overlapping shifts and dynamic depot locations, according to some example embodiments. In this case, the drivers are not expected to return to the depot by the end of the shift and can be re-routed to a new depot location based on the location of the new depot location. The re-routing is done by the simulator using a heuristic program. For any chosen shift, during each iteration, the jobs are updated based on the probabilities.

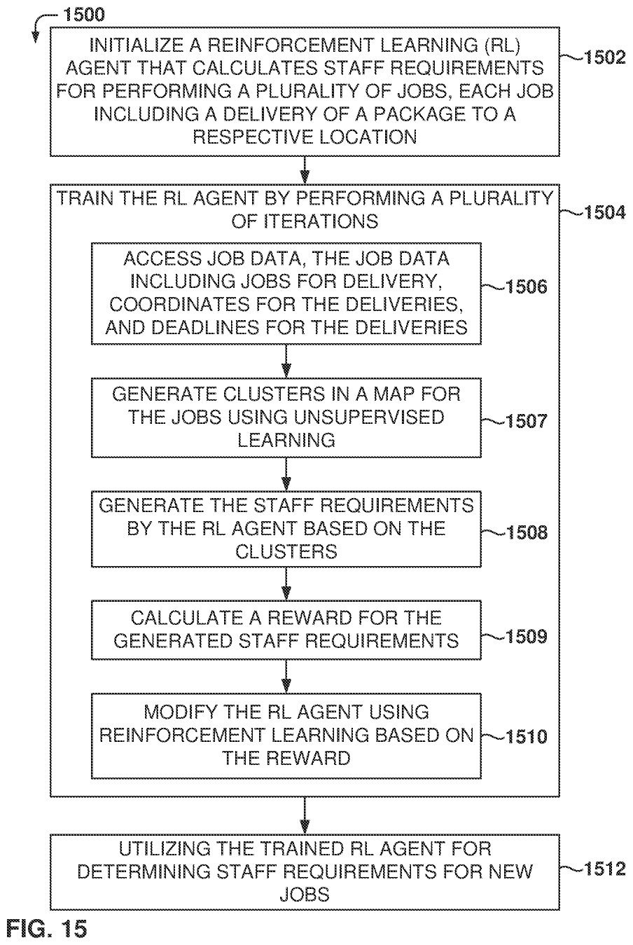

FIG. 15 is a flowchart of a method 1500 for scheduling resources used for package delivery, according to some example embodiments. While the various operations in this flowchart are presented and described sequentially, one of ordinary skill will appreciate that some or all of the operations may be executed in a different order, be combined or omitted, or be executed in parallel.

Operation 1502 is for initializing the RL agent that calculates staff requirements for performing a plurality of jobs. Each job includes a delivery of a package to a respective location.

From operation 1504, the method 1500 flows to operation 1504 for training the RL agent by performing a plurality of iterations. Each iteration comprises operations 1506-1110. At operation 1506, job data is accessed, where the job data includes jobs for delivery, coordinates for the deliveries, and deadlines for the deliveries.

From operation 1506, the method 1500 flows to operation 1507 for generating clusters in a map for the, jobs using unsupervised learning each cluster comprising one or more jobs from the plurality of jobs. At operation 1508, the RL agent generates requirements based on the clusters. Further, at operation 1509, a reward is calculated for the generated staff requirements. At operation 1510, the RL agent is modified using reinforcement learning based on the reward. The RL agent adjusts its policy according to the batch of (state, action, reward) that is collected from the environment.

From operation 1504, the method 1500 flows to operation 1512 for utilizing the trained RL agent for determining staff requirements for new jobs.

In one example, the method 1500 further includes generating synthetic data with a plurality of random job deliveries for use as the job data.

In one example, the job data further includes a probability that the job will be cancelled.

In one example, the job data further includes a probability that a new job will be created.

in one example, the job data further includes a probability that the deadline for the job will change.

In one example, generating the clusters includes creating a plurality of bins to classify the jobs, each bin including jobs to be delivered withing a corresponding delivery window of time.

In one example, the reward is calculated based on a number of drivers for the generated staff requirements and distance travelled by the drivers to make the deliveries. The distance or travel time is used by the CP. In some cases, the number of drivers and the missed deliveries are the main factors, but other factors may be considered. In some cases, statistics related to travelled distances (such as mean and standard deviation) can also be used as states.

In one example, the utilizing the trained RL agent for determining staff requirements further comprises accessing data for new jobs to deliver a plurality of new packages, and using the trained RL agent to determine staff requirements for the new jobs and routes for delivering the packages of the new jobs.

Another general aspect is for a system that includes a memory comprising instructions and one or more computer processors. The instructions, when executed by the one or more computer processors, cause the one or more computer processors to perform operations comprising: initializing a reinforcement learning (RL) agent that calculates staff requirements for performing a plurality of jobs, each job including a delivery of a package to a respective location; and training the RL agent by performing a plurality of iterations. Each iteration comprises the following: accessing job data, the job data including jobs for delivery, coordinates for the deliveries, and deadlines for the deliveries; generating clusters in a map for the jobs using unsupervised learning each cluster comprising one or more jobs from the plurality of jobs; generating the staff requirements by the RL agent based on the clusters; calculating a reward for the generated staff requirements; and modifying the RL agent using reinforcement learning based on the reward. Further, the trained RL agent is utilized for determining staff requirements for new jobs.

In yet another general aspect, a machine-readable storage medium (e.g., a non-transitory storage medium) includes instructions that, when executed by a machine, cause the machine to perform operations comprising: initializing reinforcement learning (RL) agent that calculates staff requirements for performing a plurality of jobs, each job including a delivery of a package to a respective location; and training the RL agent by performing a plurality of iterations. Each iteration comprises the following: accessing job data, the job data including jobs for delivery, coordinates for the deliveries, and deadlines for the deliveries; generating clusters in a map for the jobs using unsupervised learning each cluster comprising one or more jobs from the plurality of jobs; generating the staff requirements by the RL agent based on the clusters; calculating a reward for the generated staff requirements; and modifying the RL agent using reinforcement learning based on the reward. Further, the trained RL agent is utilized for determining staff requirements for new jobs.

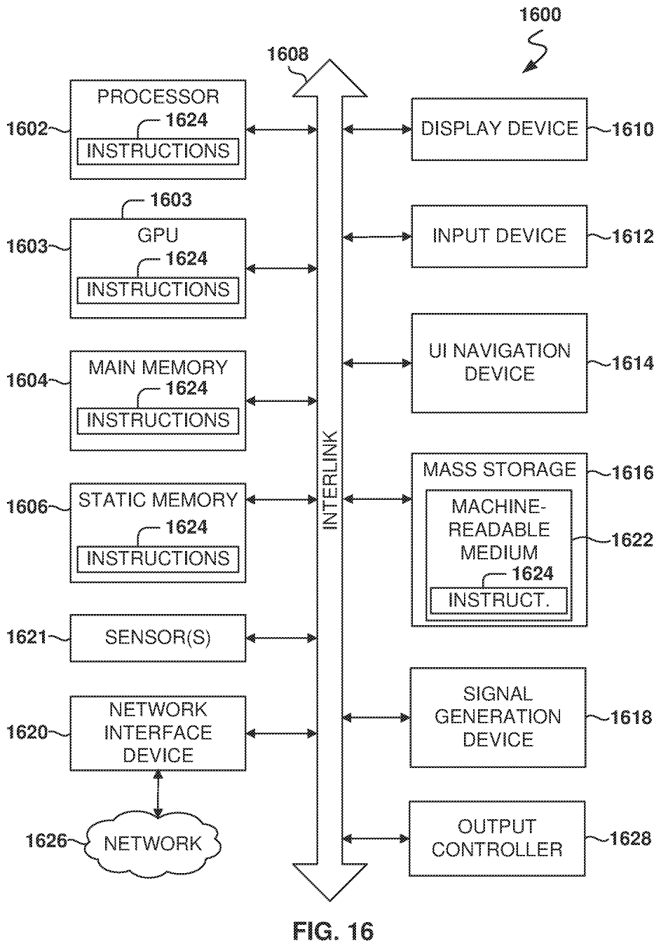

FIG. 16 is a block diagram illustrating an example of a machine 1600 upon or by which one or more example process embodiments described herein may be implemented or controlled. In alternative embodiments, the machine 1600 may operate as a standalone device or may be connected (e.g., networked) to other machines. In a networked deployment, the machine 1600 may operate in the capacity of a server machine, a client machine, or both in server-client network environments. In an example, the machine 1600 may act as a peer machine in a peer-to-peer (P2P) (or other distributed) network environment. Further, while only a single machine 1600 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable, medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1600 may include a hardware processor 1602 (e.g., a central processing unit (CPU), a hardware processor core, or any combination thereof), a graphics processing unit (GPU) 1603, a main memory 1604, and a static memory 1606, some or all of which may communicate with each other via an interlink (e.g., bus) 1608. The machine 1600 may further include a display device 1610, an alphanumeric input device 1612 (e.g., keyboard), and a user interface (UI) navigation device 1614 (e.g., a mouse). In an example, the display device 1610, alphanumeric input device 1612, and UI navigation device 1614 may be a touch screen display. The machine 1600 may additionally include a mass storage device (e.g., drive unit) 1616, a signal generation device 1618 (e.g., a speaker), a network interface device 1620, and one or more sensors 1621, such as a Global Positioning System (GPS) sensor, compass, accelerometer, or another sensor. The machine 1600 may include an output controller 16:28, such as a serial (e.g., universal serial bus (USB)), parallel, or other wired or wireless (e.g., infrared (IR), near field communication (NEC)) connection to communicate with or control one or more peripheral devices (e.g., a printer, card reader).

The mass storage device 1616 may include a machine-readable medium 1022 on which is stored one or more sets of data structures or instructions 1624 (e.g., software) embodying or utilized by any one or more of the techniques or functions described herein. The instructions 1624 may also reside, completely or at least partially, within the main memory 1604, within the static memory 1606, within the hardware processor 1602, or within the GPU 1603 during execution thereof by the machine 1600. In an example, one or any combination of the hardware processor 1602, the GPU 1603, the main memory 1604, the static memory 1606, or the mass storage device 1616 may constitute machine-readable media.

While the machine-readable medium 1622 is illustrated as a single medium, the term “machine-readable medium” may include a single medium, or multiple media, (e.g., a centralized or distributed database, and/or associated caches and servers) configured to store the one or more instructions 1624.

The term “machine-readable medium” may include any medium that is capable of storing, encoding, or carrying instructions 1624 for execution by the machine 1600 and that cause the machine 1600 to perform any one or more of the techniques of the present disclosure, or that is capable of storing, encoding, or carrying data structures used by or associated with such instructions 1624. Non-limiting machine-readable medium examples may include solid-state memories, and optical and magnetic media. In an example, a massed machine-readable medium comprises a machine-readable medium 1622 with a plurality of particles having invariant (e.g., rest) mass. Accordingly, massed machine-readable media are not transitory propagating signals. Specific examples of massed machine-readable media may include non-volatile memory, such as semiconductor memory devices Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1624 may further be transmitted or received over a communications network 1626 using a transmission medium via the network interface device 1620.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may he implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may he used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may he provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to he regarded in an illustrative rather than a restrictive sense.

What is claimed is:

1. A computer-implemented method comprising:
initializing a reinforcement learning (RL) agent that calculates staff requirements for performing a plurality of jobs, each job including a delivery of a package to a respective location; and
training he RL agent by performing a plurality of iterations, each iteration comprising:
accessing job data, the job data including jobs for delivery, coordinates for the deliveries, and deadlines for the deliveries;
generating clusters in a map for the jobs using unsupervised. learning, each cluster comprising one or more jobs from the plurality of jobs;
generating the staff requirements by the RL agent based on the clusters;
calculating a reward for the generated staff requirements; and
modifying the RL agent using reinforcement learning based on the reward; and
utilizing the trained RL agent for determining staff requirements for new jobs.

2. The method as recited in claim 1, further includes:
generating synthetic data with a plurality of random job deliveries for use as the job data.

3. The method as recited in claim 1, wherein the job data further includes a probability that the job will be cancelled.

4. The method as recited in claim 1, wherein the job data further includes a probability that a new job will be created.

5. The method as recited in claim 1, wherein the job data further includes a probability that the deadline for the job will change.

6. The method as recited in claim 1, wherein generating the clusters includes:
creating a plurality of bins to classify the jobs, each bin including jobs to be delivered withing a corresponding delivery window of time.

7. The method as recited in claim 1, wherein the reward is calculated based on a number of drivers for the generated staff requirements and distance travelled by the drivers to make the deliveries.

8. The method as recited in claim 1, wherein utilizing the trained RL agent for deters staff requirements further comprises:
accessing data for new jobs to deliver a plurality of new packages; and
using the trained RL agent o determine staff requirements for the new jobs and routes for delivering the packages of the new jobs.

9. A system comprising:
a memory comprising instructions; and
one or more computer processors, wherein the instructions, when executed by the one or more computer processors, cause the system to perform operations comprising:
initializing a reinforcement learning (RL) agent that calculates staff requirements for performing a plurality of jobs, each job including a delivery of a package to a respective location; and
training the RL agent by performing a plurality of iterations, each iteration comprising:
accessing job data, the job data including jobs for delivery, coordinates for the deliveries, and deadlines for the deliveries;
generating clusters in a map for the jobs using unsupervised learning, each cluster comprising one or more jobs from the plurality of jobs;
generating the staff requirements by the RL agent based on the clusters;
calculating a reward for the generated staff requirements; and
modifying the RL agent using reinforcement learning based on the reward; and
utilizing the trained RL agent for determining staff requirements for new jobs.

10. The system as recited in claim 9, wherein the instructions further cause the one or more computer processors to perform operations comprising:
generating synthetic data with a plurality of random job deliveries for use as the job data.

11. The system as recited in claim 9, wherein the job data further includes a probability that the job will be cancelled.

12. The system as recited in claim 9, wherein the job data further includes a probability that a new job will be created.

13. The system as recited in claim 9, wherein the, job data further includes a probability that the deadline for the job will change.

14. The system as recited claim 9, wherein generating the clusters includes:
creating a plurality of bins to classify the jobs, each bin including jobs to be delivered withing a corresponding delivery window of time.

15. The system as recited in claim 9 wherein the reward is calculated based on a number of drivers for the generated staff requirements and distance travelled by the drivers to make the deliveries.

16. A tangible machine-readable storage medium including instructions that, when executed by a machine, cause the machine to perform operations comprising:
initializing a reinforcement learning (RL) agent that calculates staff requirements for performing a plurality of jobs, each job including a delivery of a package to a respective location; and
training the RL agent by performing a plurality of iterations, each iteration comprising:
accessing job data, the job data including jobs for delivery, coordinates for the deliveries, and deadlines for the deliveries;
generating clusters in a map for the jobs using unsupervised learning, each cluster comprising one or more jobs from the plurality of jobs;
generating the staff requirements by the RL agent based on the clusters;
calculating a reward for the generated staff requirements; and
modifying the RL agent using reinforcement learning based on the reward; and
the trained RL agent for determining staff requirements for new jobs.

17. The tangible machine-readable storage medium as recited in claim 16, wherein the machine further performs operations comprising:
generating synthetic data with a plurality of random job deliveries for use as the job data.

18. The tangible machine-readable storage medium as recited in claim 16, wherein the job data further includes a probability that the job will be cancelled.

19. The tangible machine-readable storage medium as recited in claim 16, wherein the job data further includes a probability that a new job will be created.

20. The tangible machine-readable storage medium as recited in claim 16, wherein the job data further includes a probability that the deadline for the job will change.
